(19) United States
(12) Patent Application Publication
(10) Pub. No.: US 2010/0180349 A1
(43) Pub. Date: Jul. 15, 2010

(54) SYSTEM AND METHOD OF POLICY DRIVEN CONTENT DEVELOPMENT

(76) Inventors: Mahshad KOOHGOLI, Kanata (CA); Kla Mousavi, Ottawa (CA); Dhananjay Godse, Kanata (CA); Richard Mayer, Kanata (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 12/352,031

(22) Filed: Jan. 12, 2009

(51) Int. Cl. G06F 12/14; G06F 17/40; G06F 17/30

(52) U.S. Cl. 726/30; 707/E17.044

(57) ABSTRACT

A system and method for implementing a policy driven environment for the development of electronic content is provided. Such a policy driven system and method controlling the introduction of digital content into electronic content under development by monitoring the development environment for file alteration events and analyzing the file alteration event and associated metadata of the electronic content and externally introduced digital content with policy engines that address aspects such as copyright, licensing, source, file type, file length etc according to the policies established by the development organization. The system and method helping to protect the development organization by detecting policy breaches, determining the appropriate course of action, and implementing corrective actions.

### FIELD OF THE INVENTION

The invention relates to digital content management and more particularly to policy based digital content management.

### BACKGROUND OF THE INVENTION

Digital content has been developed for as long as computers have been around. It exists in the form of computer programs, text documents, digital images, digital video, digital audio, software components, and blocks of computer code. Digital content producers integrate, compile and distribute digital content production to end-users. Examples of such producers include software vendors, web site designers, and audiovisual content producers. During recent years, organizations producing digital content have chosen to leverage externally developed content to gain efficiency in research and development. As a result, some organizations have chosen to develop digital content components for distribution not to end-users but to other digital content producers. For example, some companies sell digital photographs to web-site designers/producers for use in their web sites. Another class of content producer has emerged that has chosen to produce digital content or digital content components and then distribute them for free or with liberal licenses. A subset of these free content developers has chosen to distribute their content freely, but licensed in a way that requires content producers using the free content, either directly or to produce derivative works, to release their work under the same terms. Another trend in content development is the advent and increasing use of the Internet and the world-wide web.

Through the Internet, finding digital content has become easier and faster. To the extent that it is often expedient for digital content developers and their companies to acquire digital content or digital content components from third parties, it has become acceptable to do so for producing a derivative work, rather than producing all digital content internally. Alternatively developers are increasingly merging externally sourced digital content, or digital content components, and embedding them within their own digital content. For example, a developer generating software for an MP3 music player might download and embed search programming code, allowing the user to easily search for the song they want, or an enhanced display driver produced by another developer already using the same LCD display.

Whilst the increased breadth and speed of access globally to digital content has significantly eased the digital content development process, commercial enterprises now face a problem relating to intellectual property and licensing. An ability to establish the intellectual property rights of digital content increases in complexity as developers select and embed more content from many different sources into the digital content of a commercial enterprise. In some instances, with multiple development teams globally distributed to provide 24 hour code development or addressing multiple elements of the digital content, managing the intellectual properly rights thereof becomes nearly unimaginable.

Knowing these intellectual property rights is crucial when establishing the valuation of businesses that derive revenue from generating and distributing original digital content, such as software companies, or companies that use digital content to derive revenue or cut costs, such as television broadcasters. When a business is being audited and evaluated, accurate records detailing all external digital content in the digital content systems is requested. These records include copyright ownership details, license agreements, and other terms and conditions. Given that it only takes seconds to copy significant amounts of external digital content into the digital content of a commercial enterprise, monitoring and reporting of these property rights is difficult.

For a digital content provider a typical high-level process for documenting external content is as follows:
Go through the digital content to identify and document each piece of known external digital content;
For each identified piece try to determine a source and, when a source is likely to be correct annotate the content with copyright owner, license, author(s), etc;
Compare all of your content with publicly comparable content, and if there is a match annotate the content with copyright owner, license, author(s);
For the remaining external content still not annotated, annotate them manually to the best of your ability with the copyright owner, license, author(s), etc.

Intellectual property lawyers and software experts are often brought into the digital content developer business to drive this process; key content developers and project leaders spend much time compiling these lists and reports. In reality this process is often prohibitively expensive because it requires manual labor and guesswork by highly qualified and expensive intellectual property lawyers and content developers. It is also error-prone, and subject to abuse by developers intent on hiding the source of their specific portions of the overall code forming the digital content offered by their employer or contract provider.

Levin et al in US Patent Application 2005/0125358 entitled “Authenticating Licenses for Legally-Protectable Content based on License Profiles and Content Identifiers” teaches to a method of mitigating the risk of infringing a content owner's rights in legally-protectable content by operating as a trusted, third-party license authority between content owners and content users to ensure that a license governing at least some aspects of the protectable content is authentic and thus validly represents the restrictions imposed by content owners. Unfortunately, this relies on the trust level between a developer and the trusted third party. It would, however, be beneficial to internally measure a trust level in digital content being developed.

Companies like Klockwork Inc. offer after the fact source code analysis software that checks a finished digital content for excessive code complexity, security vulnerabilities and quality defects. Unfortunately, if a problem is flagged, much time and effort has already been expended to get the digital content to the point it is at. Here again, an internal process is advantageous.

It would be advantageous to overcome some of the shortcomings of the prior art.

### SUMMARY OF THE INVENTION

In accordance with the invention there is provided a method comprising: receiving an indication that content within a first digital content file is being modified by a first modification; automatically analyzing by a policy engine the first modification in accordance with at least a policy, the at least a policy comprising at least a predetermined rule stored in association with the policy engine; when the first modification is in accordance with the at least a policy performing at least one first predetermined action of logging the modification as permitted and allowing the modification to occur; and, when the first modification is other than in accordance with the at least a policy, performing at least one second predetermined action other than the first predetermined action, the at least one first predetermined action stored in association with the policy engine and in association with a modification being other than in accordance with the at least a policy.

In accordance with another aspect of the invention there is provided a system comprising: a first computer for providing a content development system allowing a user to work with a digital content file; a file alteration monitor for automatically detecting a file alteration to the digital content file within the first computer and for generating a file alteration event in dependence thereon; a queue for having stored therein the file alteration events; a policy engine in communication with a queue for extracting from the queue a file alteration event, for executing a policy process upon data associated with the extracted file alteration event to determine a result thereof, and for at least one of forwarding a parameterized action request associated with the policy and canceling the file alteration event; a policy handler for receiving the parameterized action request and for applying the parameterized action request.

In accordance with another embodiment of the invention there is provided a method comprising: providing a content development system in execution upon a first computer and for allowing a user to work with a digital content file; providing in communication with the first computer a file alteration monitor configured with at least one type of metadata to gather in relation to the content development system; providing a policy engine having stored in association therewith at least one rule and a location of a policy handler, the policy engine for polling a predetermined portion of a queue to determine whether an event has been stored within the predetermined portion of the queue; determining that an event has occurred in dependence upon automatically detecting when the digital content file is at least one of imported, created, moved, altered, and deleted within the content development system; transmitting to a software queue, in dependence upon determining that an event occurred, at least one of the digital content file, a predetermined portion of the metadata, and a signature associated with the digital content file; upon determining that an event has been stored, retrieving with the policy engine the event and applying a policy to at least one of the digital content file, a predetermined portion of the metadata, and a signature associated with the digital content file associated with the event; dispatching an action request to a policy handler determined in dependence upon the at least one of a rule and a result of applying the rule; and executing the action request by the policy handler.

In accordance with yet another aspect of the invention there is provided a system comprising: a first computer for providing a content development system allowing a user to work with a digital content file; a file alteration monitor for automatically detecting a file alteration to the digital content file within the first computer and for generating a file alteration event in dependence thereon; a queue for having stored therein the file alteration events; a policy engine in communication with a queue for extracting therefrom a file alteration event, for executing a policy process upon data associated with the extracted file alteration event to determine a result thereof, and for at least one of forwarding a parameterized action request associated with the policy and canceling the file alteration event; and, a policy handler for receiving the parameterized action request and for applying the parameterized action request.

### BRIEF DESCRIPTION OF THE DRAWINGS

Embodiments of the invention will now be described in conjunction with the following drawings, in which:

FIG. 1 depicts a boundary between known external content and unknown external content;

FIG. 2A depicts an aspect of publicly comparable content in the context of two content developers and a public signature repository;

FIG. 2B depicts a boundary between publicly comparable content and publicly uncomparable external content;

FIG. 3 depicts the combination content assignment from gathering external content records, public comparison based annotation content, and best effort annotation content;

FIG. 4 illustrates an embodiment of the invention by outlining the format of an electronic shadow file format and electronic shadow file signatures generated from it wherein annotating the digital content file directly with licensing/copyright information associated with the digital content and confidence in such licensing/copyright information results in the electronic shadow file being updated accordingly;

FIG. 5 depicts a simplified diagram of an embodiment of the invention for controlling digital content generation from policy driven analysis of file alteration events;

FIG. 6, shows a simplified logic flow diagram of a process for tracking external content during development of digital content by a development team, according to an embodiment of the instant invention; and,

FIG. 7, shows a simplified logic flow diagram of a process for tracking external content during development of digital content by a development team, according to an embodiment of the instant invention.

### DETAILED DESCRIPTION OF EMBODIMENTS OF THE INVENTION

Currently, no solution exists to assist a development organization in the areas of detecting policy breaches, determining appropriate courses of action, and implementing corrective actions. Detecting policy violations in the digital content development environments immediately at the time of altering the digital content file would be useful, allowing the content developer time to correct the digital content file, adjust the included digital content, and correct the policy breaches prior to the delivery of the final digital content to production. More importantly, it would prevent much wasted development resources being expended on problematic content. It is also useful to be able to automatically respond with specific actions upon determining that a violation of policy has occurred. For example, a content developer could see alarms in their content development environments that indicate that a policy has been violated. Alternatively the development team leaders or quality oversight team are notified, for example by email, of violations. Further alternatively the violations could block the content developers from performing additional tasks such as running software compilers, saving the violating file to a repository or storage, etc. Of course, violations could be logged and buffered until they accumulate to a predetermined level wherein upon exceeding this predetermined level a policy control application generates violation logs, notifications, alarms, automatic suspension of user rights, etc.

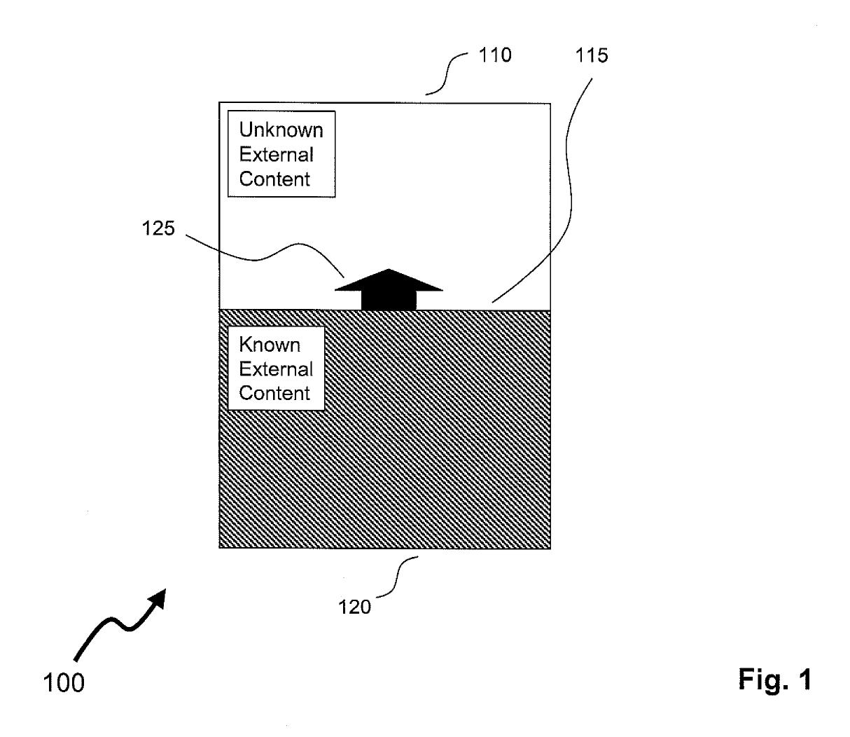

Referring to FIG. 1, there is depicted a diagram of external content 100 comprising known external content 120 and unknown external content 110. The known external content 120 and unknown external content 110 are digital content used by a developer of digital content but developed by a different developer. Examples of external content include source code files, subroutines or partial source code files, images, audiovisual content, software libraries, text and hypertext. Optionally, the external content includes partial data buffers storing displayed code, code snippets, image snippets, and audiovisual clips.

The schematic 100 in representing known external content 120 and unknown external content 110 includes a boundary 115 therebetween. The external content 100 represents a portion of the digital content for which the developer should establish proper ownership and licensure. The arrow 125 represents a desire to improve identification of external content in order to reduce an amount of unknown external content and thereby reduce commercial risk to the developer. Within the prior art the typical process of moving arrow 125 higher and reducing the unknown external content 110 involves asking the software design team to gather a list of third party components and licenses, sending the list to lawyers, and then verifying ownership.

Moving arrow 125 higher is accomplished according to an embodiment by enforcing policies within the development organization. Examples of such policies include only allowing content from specific content providers, only allowing external content with specifically documented licensing, or limiting a file size of embedded external content. Enforcement of policies based upon verifiable content further reduces errors as external content is better identified; thus errors in licensing and errors in embedded code are limited by better assuring an origin of the external content.

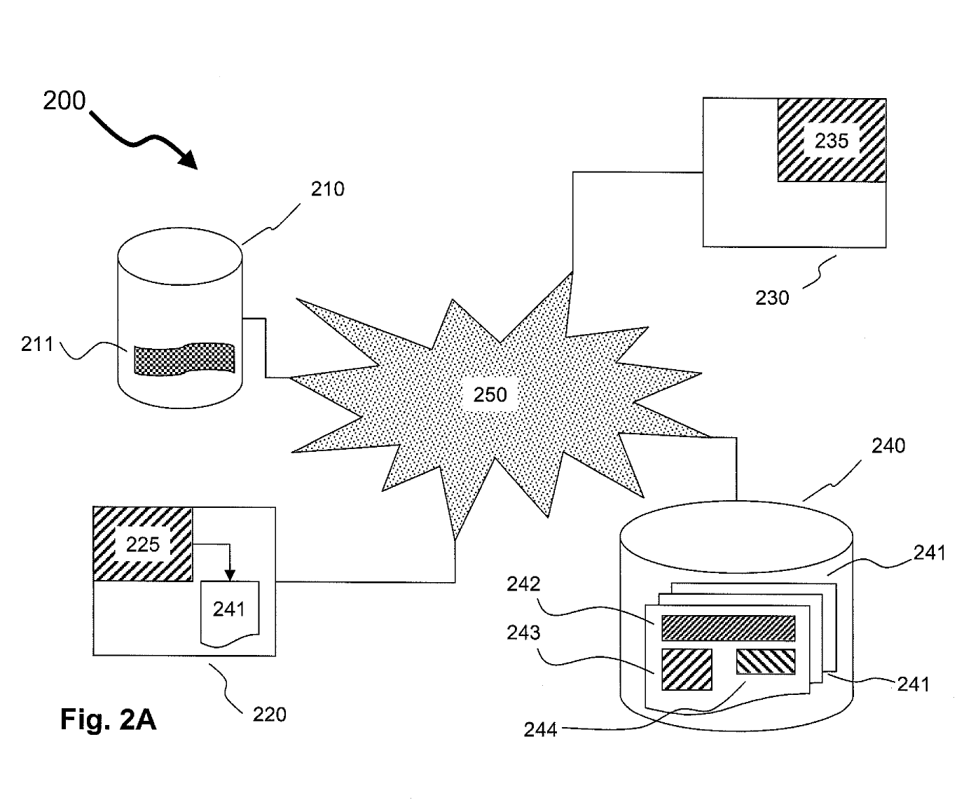

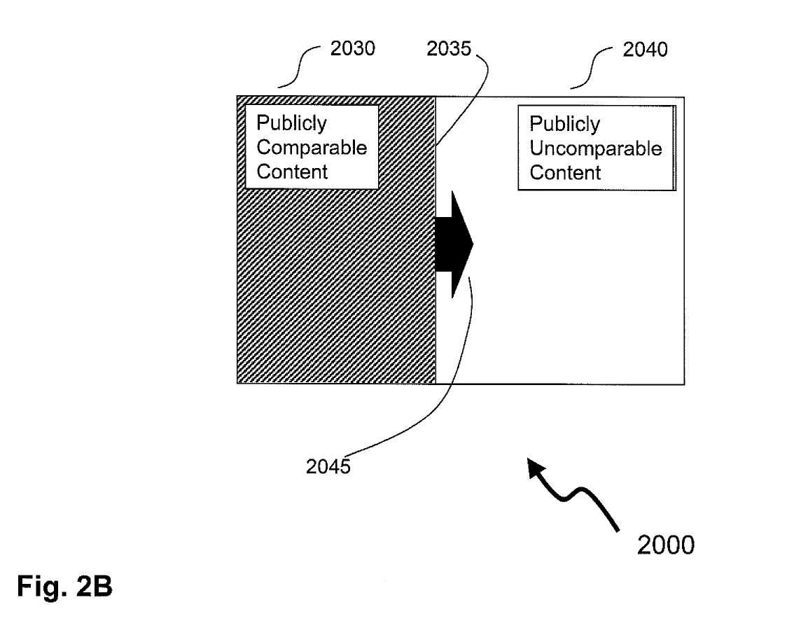

Referring to FIG. 2A, publicly comparable content 211 to address verifying and validating of external content is provided within development environment 200. Publicly comparable content 211 is digital content that is “comparable” without requiring the owner of the publicly comparable content to grant access to the comparison mechanism. The Linux kernel is an example of publicly comparable content 211 and is available for download from public servers 210. Developers compare both files and source code from within their digital content to the Linux kernel software without requiring the owners of Linux to grant permission or to provide private information about the content. As such, identifying external content that may originate from the Linux kernel is somewhat straightforward. Unfortunately, private content is much more difficult to compare without having access to the private source code and object code.

In order to provide publicly comparable private code without compromising the security of developers in respect to their code a one-way compact message digest of private content is generated and only a digital signature 241 is stored on a public server 240. Alternatively, a message digest is stored on the public server 240. As shown, in development environment 200 a first content development company 220 has a source code file 225 comprising proprietary subroutines. Accordingly, company 220 generates a digital signature 241 using a known signature process, for example Message-Digest algorithm 5 (MD5), Secure Hash Algorithm (SHA) such as SHA1, or through another process. The digital signature 241 is then stored on a known public server 240. Determinable from each digital signature 241 is the signature of the code 242, the name and contact information 243 of the copyright owner relating to the code, and licensing information 244.

At a later point in time second company 230 obtains a copy 235 of source code file 225, be it legally or otherwise. The second company 230 then digests the copy 235 and provides the digest to the public server 240 for comparison. When a match is reported, the second company 230 is informed that the first company 220 has a claim to file 235 via its original file 225. Additionally, the second company 230 also has the ability to contact the first company 220 via the name and contact information 243. Advantageously, when the licensing information 244 is stored within the data record, the second company also has foreknowledge of licensing terms for the source code.

Referring to FIG. 2B, external content 2000 comprises publicly comparable content 2030 and publicly uncomparable content 2040, there is shown a boundary 2035 between a portion of the digital content for which the developer has established proper ownership and licensure of intellectual property and the portion for which they have not. The trend arrow 2045 represents the desire to improve the identification of external content by public comparison in order to reduce the amount of unknown external content and thereby reduce commercial risk to the developer.

An association of ownership and licenses with external content within the developer's digital content decreases risks associated with externally developed digital content and intellectual property conflicts. This process is described hereinafter as annotation, described herein as comparison-based annotation and best-effort annotation, though other forms of annotation are also envisaged.

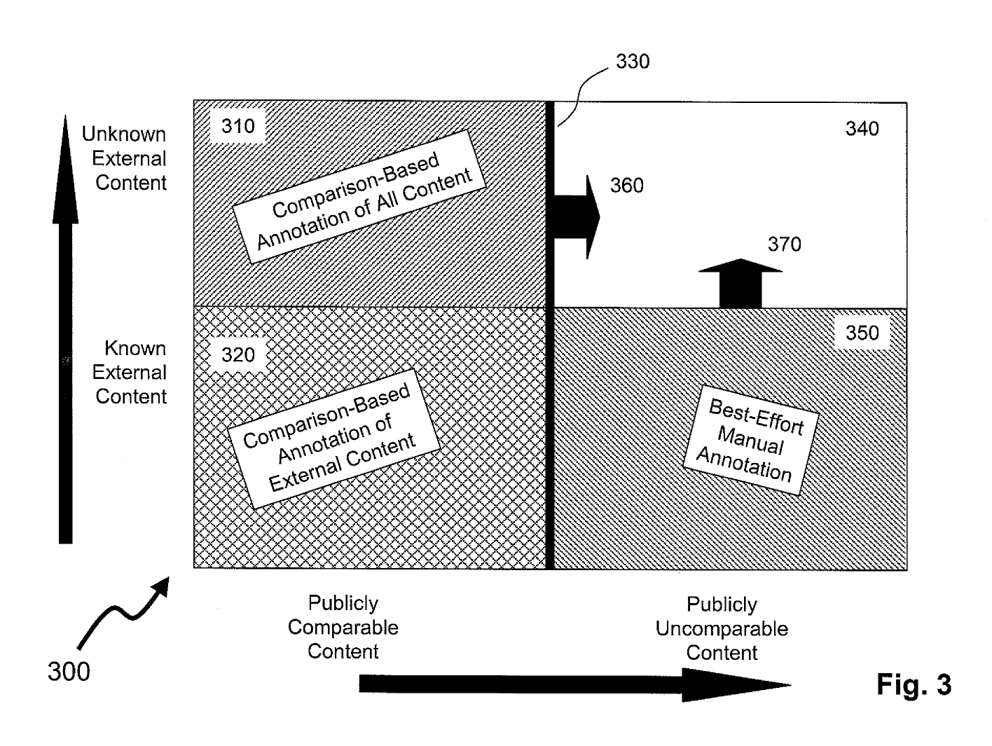

Referring to FIG. 3, the process presented hereinabove provides the second company 230 with a comparison-based annotation of external content 320 disclosed by its development team, and a comparison-based annotation of all content 310. As shown, boundary 330 does not sit to the extreme right of the external content 300 indicating that there is still external content that did not have a publicly comparable owner. To complete the process, the second company 230 performs best-effort annotation 350 on whatever content remains. In this best-effort annotation, for each element in the external content list that did not match to publicly comparable content, the second company 230 annotates the content, author, copyright ownership, and license to the best of its ability. Policy driven content determination allows these annotations to be employed in determining whether the external content is allowed or not or in determining confidence weightings for an action.

Moreover, as shown by the arrows 360 and 370 in the combination-effect schematic 300, as employed methods of external content identification improve and an amount of publicly comparable software improves, an amount of unknown external content 340 that is publicly uncomparable diminishes, thus reducing risks of intellectual property liability. While above described methods for reducing unknown external content rely upon the intentions and competence of the electronic content development team being aligned with those of company B 230, policy driven content embedding and determination reduces risks of many of these as elements such as source URL, file size, file format etc being manipulated.

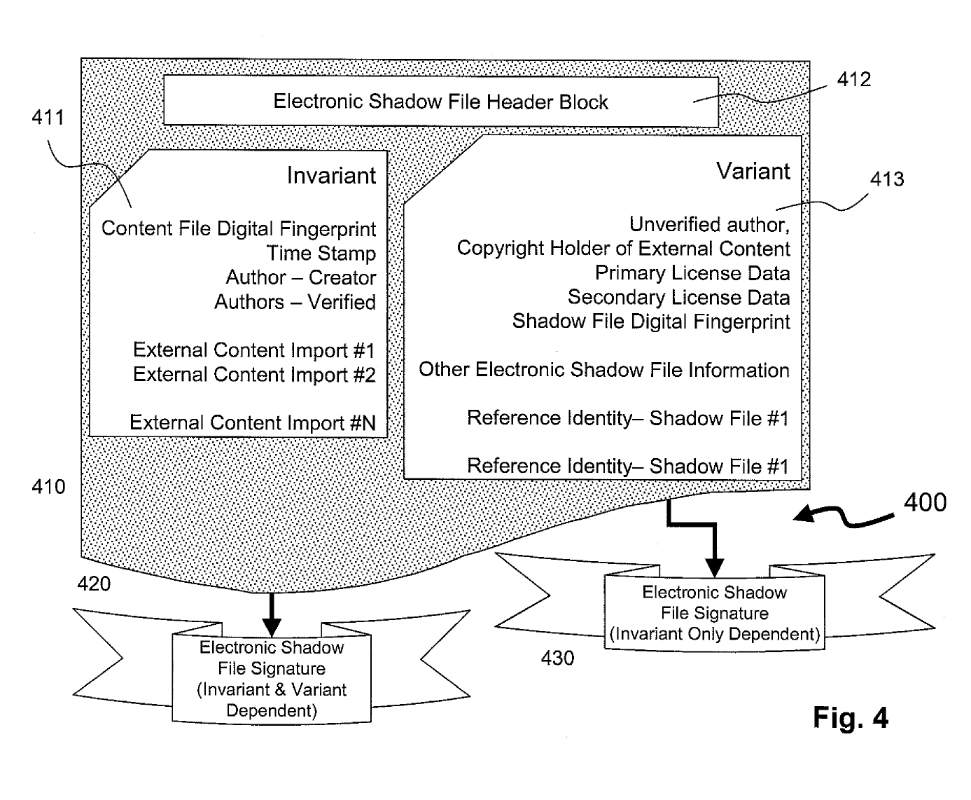

Human error is a common source of legal liability. Therefore, referring to FIGS. 4 through 7, described hereinbelow is an automated process for tracking external content during development of digital content by a development team. Though the embodiments described refer to files and buffers, other data groupings are also effective. It is advantageous to select a data grouping of sufficient size to be meaningful from an intellectual property licensing perspective.

Digital content is stored within one or more files. These include, but are not limited to, source code files, build script files, image files, audio files, video files, binary files, software libraries, text files, and hypertext files. Automating logging of creation, importing, linking, including, deleting, modification, moving, and renaming of all files used to build a system of digital content such as a software application or subsystem results in a more complete list of external content files. Any new file, which optionally is digital content over a specified predetermined size limit, is logged when appropriate as external content associated with the digital content.

Moving of digital content often relies on buffers. In some cases external content is imported into digital content files by cutting or copying and pasting, dragging-and-dropping, or by merging from other sources such as a web browser, a file browser, or from within a content-specific editor or viewer. Ultimately, each such cut-copy-and-paste, dragging-and-dropping or merging operation involves the transfer of a buffer of data from an external source into the digital content, which as noted above is logged. In this manner buffered data beyond a predetermined size that is introduced into the monitored digital content file is logged as external content associated with that file.

Policies are used to establish events and data for logging and capture thereof. For example, logging of external content is optionally restricted based on location. Location information refers to the location of either the external content or the digital content within a file system. The location within a file system of the content developer does not need generally to be logged since it is known to the content developer and easily discernable. However depending on policies location data is optionally logged. Further optionally, location data includes source location information to indicate a location from which the external content was retrieved.

Another policy relates to file types. Even in the file-system locations, folders or directories that are monitored for events as indicated hereinabove, there are potentially some files of specific types that do not ultimately lead to the production of the digital content or product and therefore do not need to have their file-system events monitored. Examples include, but are not limited to, hidden files put in every project directory by source file version control systems such as Concurrent Versions System (CVS), or Subversion (SVN, initially released in 2000 by CollabNet Inc.). Alternatively, the automated external content monitoring and digital content tracking is performed with a configuration that does not ignore file-system events for these types of files.

Automatic logging of incoming external content greatly reduces the overall cost of logging each content package, file, and snippet that content developers bring into the system, while increasing confidence in completeness of the resulting log.

In addition to logging the content it is beneficial to additionally provide additional annotations of the digital content file with licensing/copyright information for example, as well as the confidence in such licensing/copyright information. Optionally, a process of logging and annotating is implemented within a second file separate to that of the electronic content file. Examples of such a second file include databases, word processing documents, spreadsheets, an electronic shadow file, and electronic signature files.

Referring to FIG. 4, electronic shadow file format 410 and electronic shadow file signatures 420, 430 generated therefrom by a shadow file process 400 are shown. The electronic shadow file format 410 comprises a header block 412, which for example comprises reference to the electronic content file identity, an original date and time of creation, and an identity of the developer such as organization name, division, team and project reference.

The electronic shadow file format 410 comprises two data arrays, an invariant array 411 comprising invariant information elements and a variant array 413 comprising variant information elements. Invariant information elements are those data elements that do not change with the evolution of the electronic content file through actions such as editing, merging, and copying. Optionally, deleting the electronic content file does not result in changes to the invariant information. Examples of such invariant information elements include, but are not limited to, a digital fingerprint of the electronic content file as inserted, a time signature when the electronic shadow file was created, an identity of an author to whom the electronic shadow file is attributed, an identity of an author to whom the electronic content file is attributed; a verified author, and aspects of external content imported into the electronic content file.

Variant information elements are those that change over time with the different steps of copying, editing, deleting, and merging in respect of the electronic content file and external content. Examples of variant information elements include, but are not limited to, the external content itself, an unverified author, an identity of a copyright holder of external content, an aspect of a primary license associated with external content, an aspect of a license relating to external content and other than the primary license, an aspect of another electronic shadow file, and a reference identity of another electronic shadow file.

The shadow file 400 provides for generation of two electronic shadow file signatures. The first electronic shadow file signature 420 is generated using both the invariant array 411 and variant array 412 according to a signature generating process. The second electronic shadow file signature 430 is generated according to a same process but relying only upon the invariant array 411. Alternatively electronic shadow file signatures are generated using predetermined portions of each of the invariant array 411 and variant array 412, or only the variant array 412. Further alternatively, different processes are used in generating each signature.

Increased confidence in external content pedigree is of commercial benefit providing more awareness of liabilities, improved investor perceptions, increased confidence in licensing/copyright of external content. One method to achieve increased confidence is executing an external confidence process wherein external databases or centralized repositories are accessed to retrieve verified licensing/copyright documentation for external content. Alternatively or in addition, confidence is enhanceable by establishing policies within an organization developing electronic content that are enforced automatically.

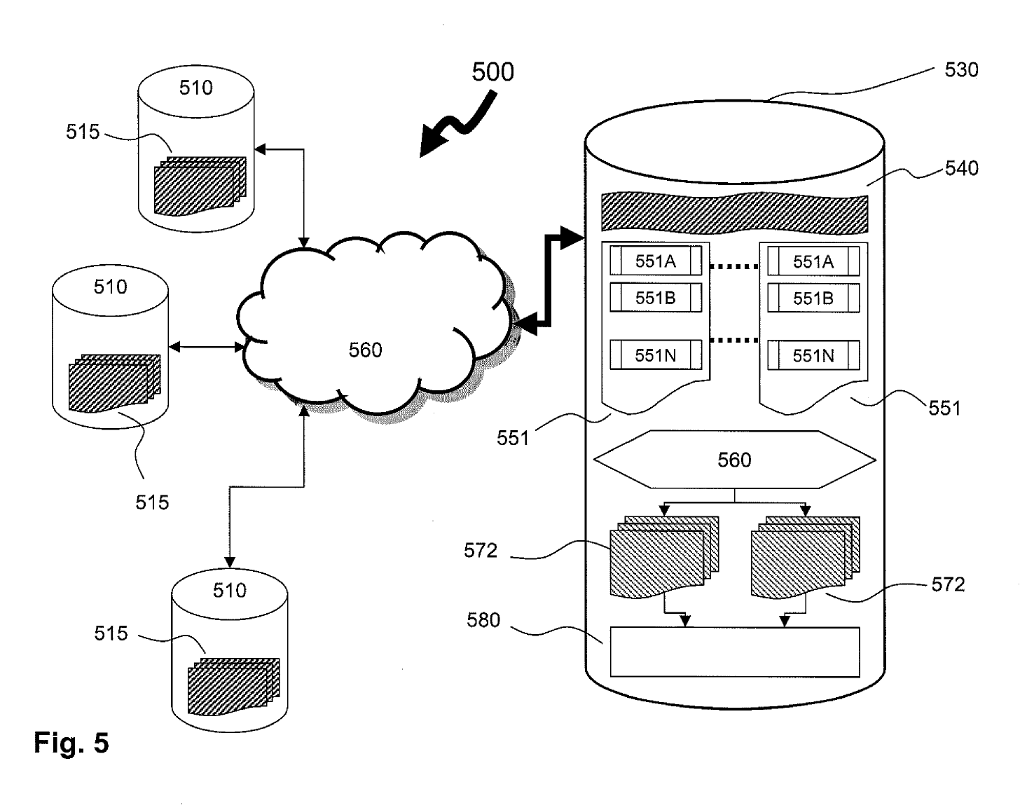

Referring to FIG. 5 shown is a simplified diagram of a system for use in applying policies in response to detecting a file alteration event for digital content under development. As shown policy control system 500 provides a process of detecting file alterations, filtering them according to policies, and taking action upon a determination of compliance/non-compliance with policy. As such, the policy control system 500 comprises a plurality of servers 510, which may be remote or local to the policy server 530, and are in communication via a network 560, such as the Internet. Each server 510 comprises digital content files 515 or compact digital content signatures (not shown for clarity) such as an electronic shadow file. The files and signatures are stored with associated metadata linked thereto, in association therewith or internal to said files and signatures. Such metadata comprises data indicative of at least some of format, license, copyright, authors, file size, language, project name, file name.

Within the policy server 530 an automatic process 540 detects when a digital content file 515 has been altered. The alteration may be within the file system of the server 510 or within the workspace of a content development environment, such as a desktop computer, laptop, server or other computer system. Upon detecting that a file alteration event has occurred, the automated process 540 transmits and saves the alteration event to one of the software queues 551. Optionally, the saved data includes associated metadata file data with the altered digital content file. Each software queue 551 comprises a plurality of file alteration events and associated metadata as event queue elements 551A through 551N. Within the policy server 530 is an application in execution, the policy engine 560 configured with a set of policy predicates. The policy engine 560 pulls a file alteration event, such as event queue element 551A, from software queues 551 and evaluates the event queue element 551A against the policy predicates.

If a policy predicate is true then the policy engine 560 transfers the event queue element 551A to one of the plurality of policy handlers 572. Each policy handler 572 takes parameterized action request from the policy engine 560 and performs the parameterized action request in combination with the event queue element 551A. Examples of parameterized actions are logging the event and data, buffering the event and data, altering the digital content file 515, altering the rights of a user, initiating the alteration, flashing an alarm, and transmitting a notification.

Optionally, file alteration monitor 540 is able to dynamically acquire metadata relating to a digital content file 515, for example from the servers 510 or from a centralized repository. Alternatively, the file alteration monitor 540 and the software queues 551 comprise one of a combination of local queues on the same workstation, remote queues on a plurality of servers, and a single queue on a computer associated with a developer.

Similarly, the software queues 551 optionally feed a plurality of policy engines 560, via a publish-subscribe message bus or via the Internet or another communication network. Alternatively, another feed method is relied upon. Each policy engine 560 is optionally configured to be general or specific. When it is a general policy engine, the policy engine receives a single file alteration event from the software queue 551 and executes all policy predicates against the event queue element 551x. When it is a specific policy engine then it evaluates a single or limited number of policy predicates. In this manner a policy engine is optionally remotely located from the source of the event and the software queues. Alternatively, policy engines are located on a same workstation as the event. In this manner flexibility is provided to the development organization in respect of centralized policy management or distributed policy management. Similarly the policy handlers 572 are optionally general in activating one of a plurality of parameterized action requests or specific to the parameterized action request they perform.

The different elements of the policy control system 500 are implementable to proactively seek a file alteration event in the case of the file alteration monitor 540 or an event queue element 551x within the software queue 551 by periodically polling other elements in the policy control system 500. Alternatively, the different elements await notification from the preceding element in the flow.

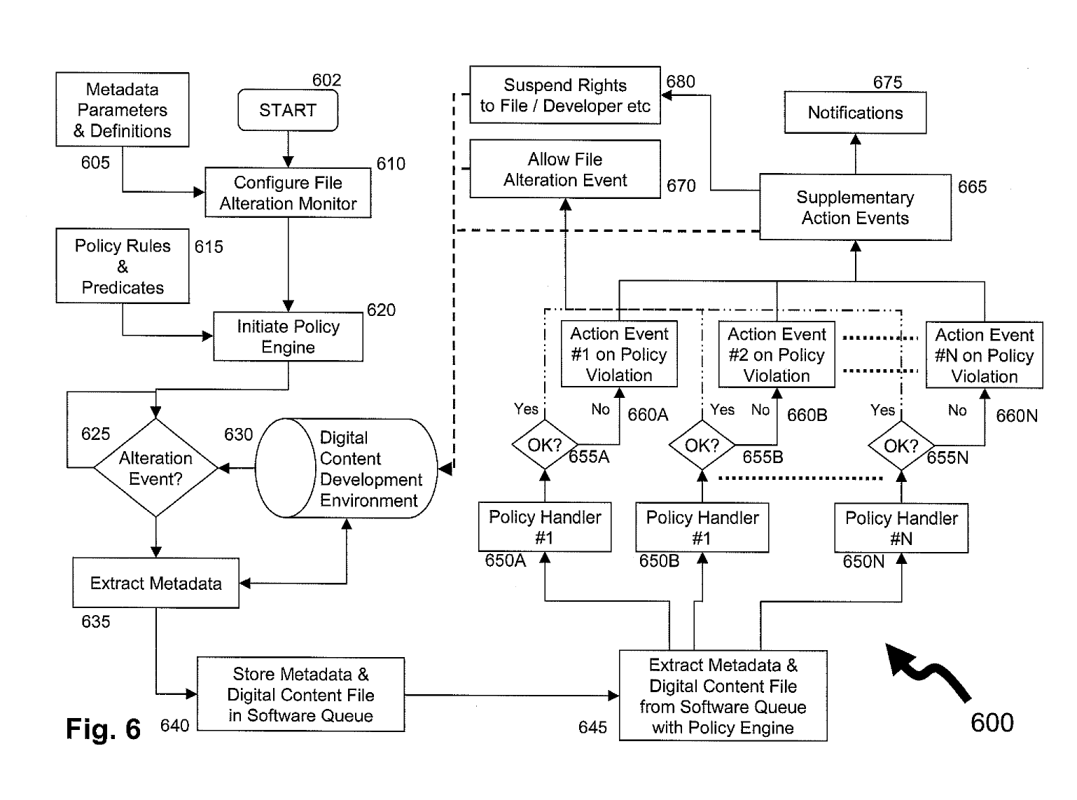

Referring to FIG. 6, shown is a simplified flow diagram 600 of an embodiment. The process starts at 602 with the initiation of a policy driven software development process. At 610 a file alteration monitor is configured with the appropriate metadata parameters and definitions established by a development organization and retrieved in 605. The process then moves to 620 and configures a policy engine with rules or predicates against file alteration events retrieved in 615.

A digital content development environment 630 provides the environment within which development teams or individuals develop electronic content and import external content for integration with internally developed content. The digital content development environment 630 interacts with the policy engine 620 to determine at 625 whether a file alteration event has occurred. If a file alteration event has not occurred then the process loops around 625. Otherwise upon detecting a file alteration event the process moves to 635 wherein metadata associated with the file alteration both in respect of the digital content file and any external electronic content introduced is retrieved and stored in association with the modified digital content file at 640 in a software queue. At 645, the policy engine establishes that a file alteration event is stored within a software queue and retrieves the digital content file and associated metadata and passes this to at least one of the plurality of policy handlers 650A though 650N.

At least one of each policy handler 650A, 650B and 650N evaluates a relevant policy rule or predicate against the digital content file and metadata such that at least a decision is made whether policy rules of the development organization have been complied with or violated. Alternatively, each of the policy handlers 650A, 650B and 650N evaluate different policy rules or predicates either in parallel or in series to result in a plurality of decisions 655A through 655N indicative of whether policy rules of the development organization have been complied with or violated. Upon determining that the policy rules have been complied with, the process at 670 allows the file alteration event to be completed—data is stored—before returning to the digital content development environment 630. Upon determining a breach of policy rules, the process continues with appropriate response action event 660A through 660N.

Upon completing each action event 660A through 660N, the process then continues at 665 wherein common supplementary action events are initiated and executed. Such supplementary actions are optionally triggered in response to sets of action events 660A through 660N or, alternatively, due to other triggers such as accumulating an overall total number of events, sequence of events, external events, or, further alternatively, in response to management criteria such as audits, probation, etc. As shown for digital content development environment 630 two such supplementary actions are indicated—notifications 675 and suspending rights 680. The rights suspended at 680 relate, for example, to one of a developer associated with the triggering event, a team associated with the digital content and the rights to accessing or modifying the digital content file itself.

As such the method shown in FIG. 6 comprises:
a) Automatically detecting when a digital content file is imported, created, moved, altered, or deleted, within the file system from which the digital content is produced;
b) Gathering metadata about the file from a list of metadata configured by a user or another;
c) Transmitting and placing the information gathered in (b) in association with the digital content file or compact signature file of the digital content file, on one or more local and remote software queues;
d) Periodically polling with at least one policy engine at least a software queue and upon detecting an event pulling the event from the software queue and evaluating same against configured predicates;
e) For each true predicate dispatching the action request, event, event data, and policy data to a policy handler; and
f) Executing the action request of the policy handler with a predetermined combination of the event, event data, policy data, buffered event, and current time as arguments, wherein the policy handler then performs at least a predetermined event. The predetermined event optionally is selected from a group comprising: logging the event and data, buffering the event and the data, altering the digital content file, altering the rights of a user associated with the digital content file, triggering an alarm, sending a notification. Optionally, along with the predetermined event, data from the file alteration event and the policy is at least one of transmitted, displayed, and logged.

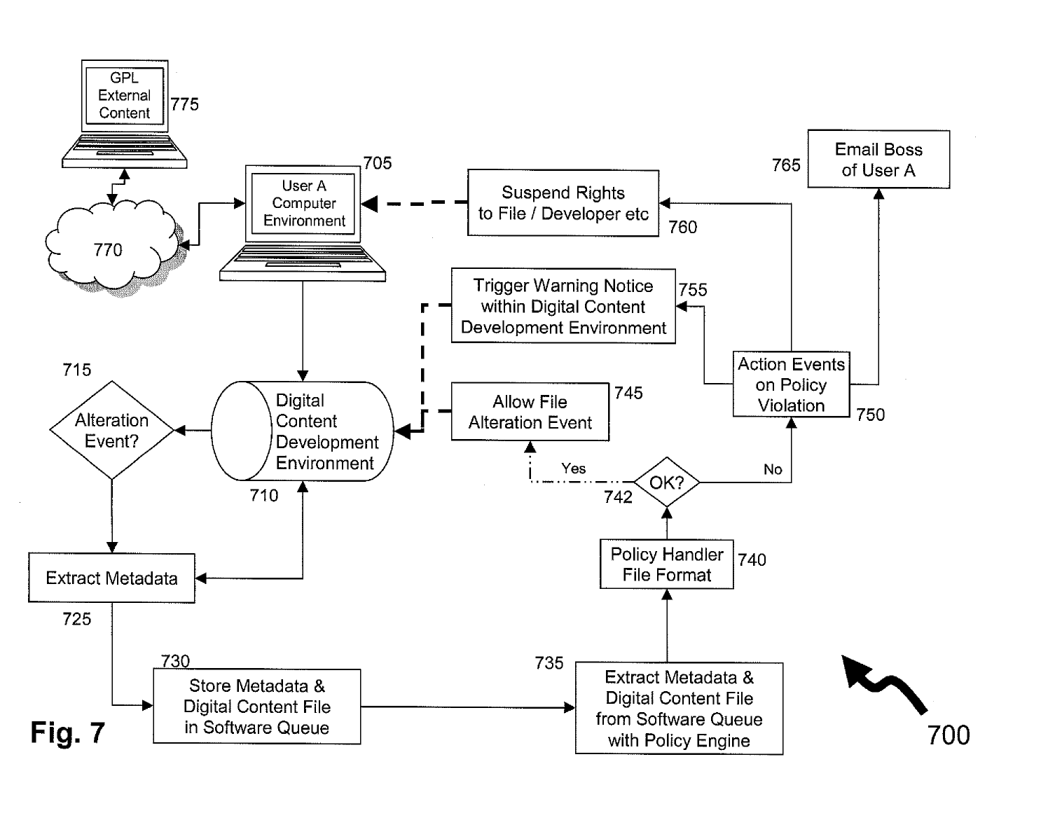

An exemplary flow diagram of an embodiment is shown in “Intellectual Property” error process 700 of FIG. 7. User A on a computer 705 is working with digital content within the digital content development environment 710 and imports from an external computer 775 via the Internet 770 a GNU General Public License (GPL) file which is embedded into the digital content they are developing within the digital content development environment 710. The importing of the GPL file and subsequent save within the digital content development environment 710 results in triggering by an alteration monitoring process of a trigger indicating an existence of an alteration event at 715.

The triggering at 715 results in the alteration process monitor extracting at 725 metadata associated with both the imported GPL file and the digital content to which the GPL file was added. At 730 the save triggered by User A is actually performed by the alteration monitor in storing the metadata extracted at 725 with both the GPL file and the digital content file at 730. Subsequently a policy engine extracts at least the metadata and digital content file and provides these to a policy engine at 735. The policy engine forwards to a policy handler data in a predetermined format and the data is evaluated against existing policy data at 740.

At step 742 a decision relating to compliance is made. Upon a compliant result process at 745 completes the modification request and returns to a valid digital content development environment 710. Upon a non-compliant result the process at 750 whereupon action events in response to non-compliance are initiated. Here, these include 755, 760 and 765 determined in dependence of the policy violation. A warning notice is triggered at 755 which is presented to users within the digital content development environment 710, suspension of user rights for file alteration occurs at 760 which is provided to User A via computer 705, and a sending of an electronic notification of the policy violation to User A's superiors at 765.

Optionally triggering of the file alteration monitor into storing the digital content file and metadata locks the digital content file until the policy handlers and policy engine have completed their analysis. In this manner additional modifications to the digital content file are blocked until the current alteration is resolved against the policies of the development organization. Alternatively each alteration event is stored within a software queue and modifications continue unabated, each storing additional alteration events within the software queue or software queues. In this later case the policy engines may retrieve alteration events in first in-first out (FIFO), first in-last out (FILO), last in-first out (LIFO), in groupings—events modifying a same digital content portion grouped together, randomly, or according to another predetermined ordering.

In general a policy is a predicate set of conditions on metadata which make the predicate true, exceptions that make the predicate false, and then at least an action to execute when the policy predicate within the metadata has the conditions true and exceptions false. In one embodiment of the invention, the policies themselves are described by the following Backus-Naur Form:

policies = policy | policies “OR” policy
policy = metadata “:” conditions exceptions action
conditions = condition | conditions “AND” condition “;”
exceptions = exception | exceptions “AND” exception “;”
metadata = “METADATA” literal
condition = “CONDITION” binaryOperator value “,”
exception = “EXCEPT” binaryOperator value “,”
action = “ACTION” literal
binaryOperator = “<” | “<=” | “>” | “>=” | “=”
literal = [a-zA-Z1-9]+
value = [a-zA-Z1-9]+

Embodiments of the invention support a development organization with benefits which include but are not limited to:
a) The ability to proactively take action on file alteration events that have been deemed unsuitable for their goals;
b) Policy grammar gives the organization flexibility in implementing policy predicates without requiring code changes in the policy engine;
c) Optional plurality of local and remote queues, policy engines, and policy handlers gives the organization the flexibility to get the desired mix of centralized and localized control over how to handle policy actions;
d) Configuring the desired metadata allows irrelevant metadata to be discarded easily;
e) Separation of the policy handlers allows the definition and execution of highly customized actions in response to filtered file alteration events; and
f) Reporting gives management visibility into policy and violations and/or evaluation results, and it proactively guides content developers into developing suitable content.

Alternatively, policy reporting occurs upon a different threshold to resulting actions such that when policies are followed in particular fashions, notification of these activities are made so that monitoring and auditing of policies and their application is supported.

Numerous other embodiments may be envisaged without departing from the spirit or scope of the invention.

What is claimed is:

1. A method comprising:
receiving an indication that content within a first digital content file is being modified by a first modification;
automatically analyzing by a policy engine the first modification in accordance with at least a policy, the at least a policy comprising at least a predetermined rule stored in association with the policy engine;
when the first modification is in accordance with the at least a policy performing at least one first predetermined action of logging the modification as permitted and allowing the modification to occur; and,
when the first modification is other than in accordance with the at least a policy, performing at least one second predetermined action other than the first predetermined action, the at least one first predetermined action stored in association with the policy engine and in association with a modification being other than in accordance with the at least a policy.

2. A method according to claim 1 comprising:
providing a content development system operating upon a first computer for allowing a user to modify the first digital content file.

3. A method according to claim 1 comprising:
providing a file alteration monitor configured for gathering at least one type of metadata relating to external content.

4. A method according to claim 1 comprising:
providing data relating to a location of a policy handler, the policy handler comprising the policy engine.

5. A method according to claim 1 comprising:
automatically detecting when the first digital content file is at least one of imported, created, moved, altered, and deleted;
modifying metadata associated with the first digital content file in response to automatically detecting; and,
providing the indication.

6. A method according to 5 wherein the indication comprises: at least one of the digital content file, metadata relating to the first digital content file, metadata relating to external content imported into the first digital content file, and a signature associated with the digital content file.

7. A method according to claim 6 comprising:
storing the indication within a queue, the queue for being accessed by at least a policy engine for retrieving the indication and automatically analyzing same.

8. A method according to claim 7 comprising:
polling by a policy engine a predetermined portion of the queue to determine whether an indication has been stored within the predetermined portion of the software queue.

9. A method according to claim 1 comprising:
dispatching an indication of the at least one first predetermined action stored in association with the policy engine to at least one policy handler; and
executing the at least one first predetermined action by the at least one policy handler.

10. A method according to claim 1 wherein the policy engine is in execution on a computer system other than a computer system on which a first modification of the first digital content file occurs.

11. A method according to 1 wherein the at least one first predetermined action comprises at least one of logging the first modification and metadata associated therewith, buffering the first modification and metadata associated therewith, altering the first digital content file, altering rights of a user associated with at least one of the event and the first digital content file, triggering an alarm, transmitting a notification, and preventing storage of the first digital content file as modified.

12. A method according to claim 9 wherein executing the at least one first predetermined action comprises at least one of transmitting, displaying, and logging at least one of the first modification and data derived from the first modification.

13. A method according to claim 3 wherein the metadata comprises data relating to an aspect of at least one of the first digital content file and an external content file being combined with the first digital content file in accordance with the first modification, the aspect selected from the group consisting of a file length, a file size, a file type, a file format, an author, a copyright, a license, an owner, and an aspect of a digital content.

14. A method according to claim 1 wherein the at least a predetermined rule relates to an aspect of the first modification, the at least a predetermined rule selected from the group consisting of adding content of a specific file format, adding content of a specific operating system, adding content without a predetermined level of authenticity, adding content without a predetermined level of licensing, adding content without a predetermined level of copyright, adding content generated by a predetermined developer, and adding content generated by a predetermined organization.

15. A method according to claim 7 wherein the queue comprises a publish-subscribe group comprising at least one queue and at least one policy engine.

16. A system comprising;
a first computer for providing a content development system allowing a user to work with a digital content file;
a file alteration monitor for automatically detecting a file alteration to the digital content file within the first computer and for generating a file alteration event in dependence thereon;
a queue for having stored therein the file alteration events;
a policy engine in communication with a queue for extracting from the queue a file alteration event, for executing a policy process upon data associated with the extracted file alteration event to determine a result thereof, and for at least one of forwarding a parameterized action request associated with the policy and canceling the file alteration event;
a policy handler for receiving the parameterized action request and for applying the parameterized action request.

17. A system according to claim 16 wherein,
the queue is on a computer system other than the first computer.

18. A method according to claim 16 wherein the system consists of a plurality of processes in execution on a single computer.

19. A method according to claim 16 wherein the system comprises a plurality of processes in execution on a plurality of computers for working in cooperation.

20. A method comprising:
providing a content development system in execution upon a first computer and for allowing a user to work with a digital content file;
providing in communication with the first computer a file alteration monitor configured with at least one type of metadata to gather in relation to the content development system;
providing a policy engine having stored in association therewith at least one rule and a location of a policy handler, the policy engine for polling a predetermined portion of a queue to determine whether an event has been stored within the predetermined portion of the queue;
determining that an event has occurred in dependence upon automatically detecting when the digital content file is at least one of imported, created, moved, altered, and deleted within the content development system;
transmitting to a software queue, in dependence upon determining that an event occurred, at least one of the digital content file, a predetermined portion of the metadata, and a signature associated with the digital content file;
upon determining that an event has been stored, retrieving with the policy engine the event and applying a policy to at least one of the digital content file, a predetermined portion of the metadata, and a signature associated with the digital content file associated with the event;
dispatching an action request to a policy handler determined in dependence upon the at least one of a rule and a result of applying the rule; and
executing the action request by the policy handler.

21. A system comprising:
a first computer for providing a content development system allowing a user to work with a digital content file;
a file alteration monitor for automatically detecting a file alteration to the digital content file within the first computer and for generating a file alteration event in dependence thereon;
a queue for having stored therein the file alteration events;
a policy engine in communication with a queue for extracting therefrom a file alteration event, for executing a policy process upon data associated with the extracted file alteration event to determine a result thereof, and for at least one of forwarding a parameterized action request associated with the policy and canceling the file alteration event; and,
a policy handler for receiving the parameterized action request and for applying the parameterized action request.
